(19) United States
(12) Patent Application Publication
(10) Pub. No.: US 2002/0082973 A1
(43) Pub. Date: Jun. 27, 2002

(54) Intellectual property bid method and system

(76) Inventors: Alain Marbach, Belmont, MA (US); Richard A. Baker, West Newbury, MA (US); Edward S. Jarmolowicz, Webster, MA (US)

Correspondence Address: Larry I. Golden, Square D Company, 1415 South Roselle Road, Palatine, IL, 60067, US

(21) Appl. No.: 09/749,198

(22) Filed: Dec. 27, 2000

(51) Int. Cl. G06F 17/60

(52) U.S. Cl. 705/37

(57) ABSTRACT

A method, system, and computer program product for auctioning intellectual property. An intellectual property owner identifies property to be placed at auction. The owner further defines the license information including a license right type, a business right type, and an intellectual property use type, which taken together with the property determines the minimum bid amounts. The method and system sends the bidder a bid form prompting the bidder to enter in the above mentioned information, and the bidders contact information. Upon receipt, the system registers the bidder and sends the validated bid amount information, not including the bidders registration information, to the owner for evaluation and selection of the winning bidder. All received bids are maintained in confidence, until the winning bidders are contacted at the auction's conclusion, while all non-winning bids are deleted.

### BACKGROUND OF THE INVENTION

1. Field of the Invention

The present invention relates generally to the use of an auction, and more particularly, to a method, system, and computer program product for an intellectual property auction. The invention is directed to the auction of intellectual property among competitors and individuals, which desire to have confidentiality throughout the auction process.

2. Discussion of the Background

Auctions have been used to sell many types of property. In the past, people related auctions to the buying and selling of unique objects such as cars, furniture, and other objects of antique value. Today, auctions proliferate on the Internet for the buying and selling of goods. For example, eBay.com, uBid.com and Priceline.com are popular web sites to buy or sell goods. Other industry specific web sites for buying and selling have emerged, such as the U.S. Navy buying consortium at www.abm.rda.hq.navy.mil/rbc/navcons/index.

In addition, Internet auction sites have emerged for intellectual property. Web sites such as yet2.com, PatentAuction.com, PATEX.com, p-lx.com and even, eBay.com have offered intellectual property, mostly patents, for purchase or license. The patent auction web sites attempt to sell other services that include strategy development, intellectual property assessment and valuation, contract negotiations, and royalty recovery. In addition, the web sites allow the visitor to hyperlink, that is, transfer to another web site for legal services and other intellectual property offerings.

The Web sites mentioned suffer from an inability to maintain confidentiality over the bid information submitted. More importantly, the Web sites have no method in place that establishes true market value for the intellectual property auctioned. The patent auction web sites employ the word “auction,” but in reality the patent auction sites store in a database the intellectual property of a participant for a fee. The fee might be an entrance fee, or a percentage fee based upon a license granted by the intellectual property participant. Anyone interested in determining the existence of a patented technology need only visit the USPTO web site at www.USPTO.gov. The user can search the USPTO database for the technology, download a portion of the patent, then if they have further interest, order a copy and contact the patent assignee for a possible license.

Like the patent auction sites and the USPTO searchable databases, the potential licensee would need to expose himself or herself to the patent holder. Depending upon industry competition, the patent holder having the right to exclude may refuse to license the technology. This right to exclude and right to use creates the barrier of entry for a potential licensee-competitor into a specific industry, or into an equivalent industry. An equivalent industry means an industry that can use the patented technology, but the licensee is not a direct competitor. Moreover, the potential licensee might not make contact with a competitor holding a patent. The competitor demonstrating an interest in a particular technology might draw unwanted attention to their products. In addition, the patent holder may attempt to license at a higher rate then the patent's value when the competitor holds a market position. More importantly, the patent holders but for the competitor's interest, may not have known that the competitor might be infringing the patent or one of its claims with one of the competitor's products or future products.

Buyers of intellectual property desire true market value to help determine the fee paid to an intellectual property owner. Any fee paid for the right to use intellectual property of another a buyer may need to increase their price over that of a competitor. Any price increase leads to reduced sales without a competitive advantage from the licensed intellectual property. It is difficult for a buyer to determine the post-effect of a price increase when negotiating a fee to use another's intellectual property. A true auction should theoretically provide the best market price. In addition, bidders with a business interest would be more likely to bid at a secure, closed auction, and thus, be willing to add the cost of the license to their product.

An auction normally starts at a set price and then the price decreases over time as the auction period extends with a sufficient volume purchase. Likewise, an auction starting a set price can increase as the interested bidders bid against each other. Some of the auction patents describe a method to perform an auction, such as an English or Dutch auction. Other patents describe auctions to many participants over a plurality of computers, such as found on the Internet. These auction patents address the inability of a user to be present at the auction and help to ensure the largest number of participants to obtain a competitive price—a desired result of an auction that attracts bidders. In addition, other patents issued direct its technology to the buying and selling of consumer goods.

Some systems allow bidders to pool their bids to obtain the lowest price for a quantity of goods auctioned. Goods can be consumer products such as books, cameras, and even computer devices. These systems allow bidders, over large geographic areas, to participate but bidders disclose their identity. To participate, the bidders register by providing financial information that the on-line auction can use to cause immediate payment at auction completion. Consumer goods, unlike intellectual property, usually depend upon a high sales volume to make an auction profitable. Likewise, intellectual property, unlike consumer goods, is a more detailed and involved financial transaction. For example, the intellectual property license fee might be based upon future sales levels, an unknown variable at auction time. A similar system is described in U.S. Pat. No. 5,794,219 issued to Brown on Aug. 11, 1998 and U.S. Pat. No. 6,023,686 issued to Brown on Feb. 8, 2000 which are incorporated herein by reference. Another similar system is described U.S. Pat. No. 4,789,928 issued to Fujisaki on Dec. 6, 1998 which is incorporated herein by reference. Still other similar systems are described in U.S. Pat. No. 6,012,045 issued to Barzilari on Jan. 4, 2000 and in U.S. Pat. No. 5,835,896 issued to Fisher on Nov. 10, 1998 both incorporated herein by reference.

Other systems provide for large-scale auctions with the purpose of keeping the buyer's bidding against each other for the longest possible period of time. The buyer submits a bid price and bid time duration for that price. This system, like many auction patents, works over a network of computer systems to obtain the largest number of participants. Unlike intellectual property usually having a finite number of bidders, auctioning consumer goods can potentially include every legal bidder in the world that is capable of bidding. These systems extend the auction period to increase the number of units auctioned to keep the price low on the commodity auctioned. For example, a commodity is a product generally available in the market and having a known price, such as wheat, soybeans, or paper goods. Intellectual property is not a commodity, but an asset of finite quantity—no two patents are alike. Moreover, buyers of intellectual property rely upon its market value to make a profit from its use. For example, the intellectual property might a patent. A competitor may only need one claim from the patent. A similar system that extends the auction period is described in U.S. Pat. No. 6,151,589 issued to Aggarwal on Nov. 21, 2000 which is incorporated herein by reference.

Yet other systems provide for securing the auction transaction itself, in a network of computers having servers and bidding terminals. The servers contained the auction information and receive bids from the bidders at their computer terminals. The computer terminals are usually in a remote location and communicate over a network, such as the Internet, to the servers. The Internet is a network interconnecting many communication points at which the computer terminals are connected for the purpose of transmitting and receiving information from the servers. These systems secure the auction transaction with the purpose of attempting to mirror a secured bid to prevent disclosure until the end of the auction.

Unlike these systems, intellectual property bid amounts should be revealed. Bidders bidding on intellectual property need to know its true market value. The market value of the intellectual property is the expected revenue from its use in the bidders business. Revealing the bid amounts during the course of the auction allows the bidders to justify their bid amounts and to learn the market value of the intellectual property. At some point during the auction, a bidder may cease to bid because the bid price has exceeded their perceived value to the business. A similar system that secures bids is described in U.S. Pat. No. 6,055,518 issued to Franklin on Apr. 25, 2000 which is incorporated herein by reference.

Other systems provide for automatic auctions, whereby, remote bidders submit a price, number of product purchases, volume of each product purchased, and the highest possible bid price. With these systems a bidder usually has to submit their bids prior to the start of the auction. The system uses the submitted bids during the bidding time period, as the volume of product becomes available. Intellectual property is usually finite, if a patent, or unique, if a copyrighted software product. With a volume typically of one, the intellectual property bidder usually has one maximum price. In other words, intellectual property is not sensitive to volume discounting, which these systems are based upon. A similar system is described in U.S. Pat. No. 6,044,363 issued to Mori on Mar. 28, 2000 that is incorporated herein by reference.

Still other systems provide mathematical methods to determine a winning bid based upon a set of bids. For example, auctions typically have many products. Bidders offer different prices for each product, or one price for a group of products offered as a set. These auctions create many combinations that these systems analyze to determine the highest price. These systems use mathematical algorithms to aid in determining the winning bid among a group of bidders. Unlike intellectual property having a finite value, these systems work best having a large number of bidders, bidding on a number of products at varying volumes. A similar system is described in U.S. Pat. No. 6,021,398 issued to Ausubel on Feb. 1, 2000 which is incorporated herein by reference.

Last, other systems provide for auctioning consumer loans over a computer network. In these systems, the systems accept a borrower's electronic application, approves the application, and places the application in a database for other lending institutions to review and bid on. Unlike intellectual property auctions that rely upon concealing the identity of the bidder from the intellectual property owner, these systems rely upon full disclosure of the identity of all parties. A similar system is described in U.S. Pat. No. 5,966,699 issued to Zandi on Oct. 12, 1999 which is incorporated herein by reference.

### SUMMARY OF THE INVENTION

Accordingly, one object of this invention is to provide a novel method, system, and computer program product for auctioning intellectual property among and between industry competitors.

It is another object of the present invention to provide a novel method, system, and computer program product to maintain bidder confidentiality beyond the termination of the intellectual property auction, except for the winning bidder at the conclusion of the auction

It is another object of the present invention to provide a novel method, system, and computer program product for a bidder to place multiple bids against the same intellectual property under different license type conditions depending upon business use and field of use of the intellectual property, particular to the bidder.

It is another object of the present invention to provide a novel method, system, and computer program product to maximize the revenue on a piece of intellectual property for the intellectual property owner.

It is another object of the present invention to provide a novel method, system, and computer program product to increase competitor participation by providing a secure bidding environment and by creating multiple-product offerings of the same intellectual property.

It is another object of the present invention to provide a novel method, system, and computer program product to reduce the transaction time and cost to sell the intellectual property rights, while giving the buyer confidence that its purchase price represents market value of the property.

It is another object of the present invention to provide a novel method, system, and computer program product for an intellectual property owner to identify under performing property in its portfolio and to market the intellectual property to a targeted audience of competitors having an unexpressed interest in obtaining some rights in the property, without exposing their competitive interest during negotiations.

These and other objects are achieved according to the present invention by providing a novel method, system, and computer program product for auctioning intellectual property. The intellectual property auction starts with the intellectual property owner identifying an intellectual property, such as a patent. The intellectual property may include a patent, a patent claim, a software program, a manufacturing process or technique. The intellectual property owner identifies potential buyers of the property, including competitors. Potential buyers may come from patent references, industry associations such as IEEE, or bidders making contact with the third party auctioneer. This third party operates the registration server system and bid analysis system, which registers bidders, accepts bids, and determines the winning bid.

The owner submits the buyer list and intellectual property to the bid analysis system. The independent, third party controlled bid analysis system targets the potential buyer with a specific license contract. The owner previously identified the buyer and its license type based upon the owner's market research and understanding of the competitive situation. The buyer registers and bids on the offered intellectual property. To register and bid, the buyer submits a minimum bid, signs the standard license contract, and returns the bid information to the bid analysis system administrator. The bid analysis system validates the bid information, evaluates the bids, and determines the winning bid. After determining the winning bids, the system makes contact with the bidder and obtains the necessary signatures on the final legal documents. The system notifies the intellectual property owner of the winning bidders. The system deletes the non-winning bids from the databases and destroys any documentation.

In an embodiment of the invention, the buyer changes the license type, business use, and intellectual property use. This change allows a bidder to make multiple competitive bids to secure a legal right particular to its need. As a result of the change, the bid amount information will be validated to meet a new minimum bid amount. For this invention, the bid amount information for the license type, business use, and intellectual property use does not go below a floor value. The floor value is the opening bid amount for all bidders selecting the same license type, business use, and intellectual property use for the same intellectual property. Bidding starts at the floor value and increases with the number of bidders bidding for the same license type, business use, and intellectual property use. But no bid amount can go below the floor value set by the intellectual property owner in the bid analysis system, prior to the start of the bidding.

In an another embodiment of the invention, the intellectual property owner can submit a single claim of its patent to the bid analysis system. The buyer can select the suggested license type, business use, and intellectual property use or the buyer can change anyone of the use categories to bid on. The intellectual property owner has submitted the minimum bid amount information for individual patent claims auctioned.

In yet another embodiment, the buyer can select to purchase the right to use and the right to exclude for a specific business use. The buyer can resubmit the purchased intellectual property right to the bid analysis system for auction, but with the business use fixed. Having the rights, the buyer's market understanding or distribution channel may be better able to target potential bidders than the then existing intellectual property owner.

In order to take advantage of the invention, the buyer has a mechanism to maintain confidentiality over its bid information under any embodiment in perpetuity. The bid analysis system maintains the bidder's registration information separate from the bid itself, by assigning an arbitrary bid number to the bid. The registration database maintains a relationship between the bid number and the unique registration number of the bidder. The intellectual property owner should not have access to the registration database. The bid analysis system secures the unique registration number from the intellectual property owner. The bid analysis system indexes the bid number based upon the unique registration number in a manner that the intellectual property owner can only access the bid number. Once the intellectual property owner selects the winning bids based upon license type, business use, and intellectual property use the owner submits the bid number to the bid analysis system. The bid analysis system contacts the unique registration number notifying them that the intellectual property owner selected the bidder as the winning bid. And the intellectual property owner has signed the standard license contract; thereby, accepting the bidder's firm offer. All other bids for the auction of the intellectual property are deleted from the bid analysis database.

### BRIEF DESCRIPTION OF THE DRAWINGS

The present invention will be described in the following portions of the specification when taken in conjunction with the attached drawings in which:

FIG. 1 is a block diagram illustrating the intellectual property bid method and system;

FIG. 2 is a block diagram illustrating the registration system server and the bid analysis system.

FIG. 3 is a drawing of a data structure for storing the registration information provided to participate in the bid analysis system.

FIG. 4 is a drawing of a data structure for storing the bid analysis information provided by the bidder for the bid analysis systems.

FIG. 5 is a flowchart illustrating the intellectual bid method and system.

FIG. 6 is a flowchart illustrating a bidder's use of the registration server system.

FIG. 7 is a flowchart illustrating the receiving of the bid information and the bid amount information.

FIG. 8 is a flowchart illustrating the evaluating, selecting and notifying the winning bidder from among a plurality of bidders.

FIG. 9 is a drawing of the bidder bid form containing the minimum required amount of bid information to place a bid with the bid analysis system.

FIG. 10 is a schematic diagram of a general purpose computer system 1001 that can be programmed to perform the special purpose function(s) of one of more of the devices shown in FIG. 1.

### DESCRIPTION OF THE PREFERRED EMBODIMENTS

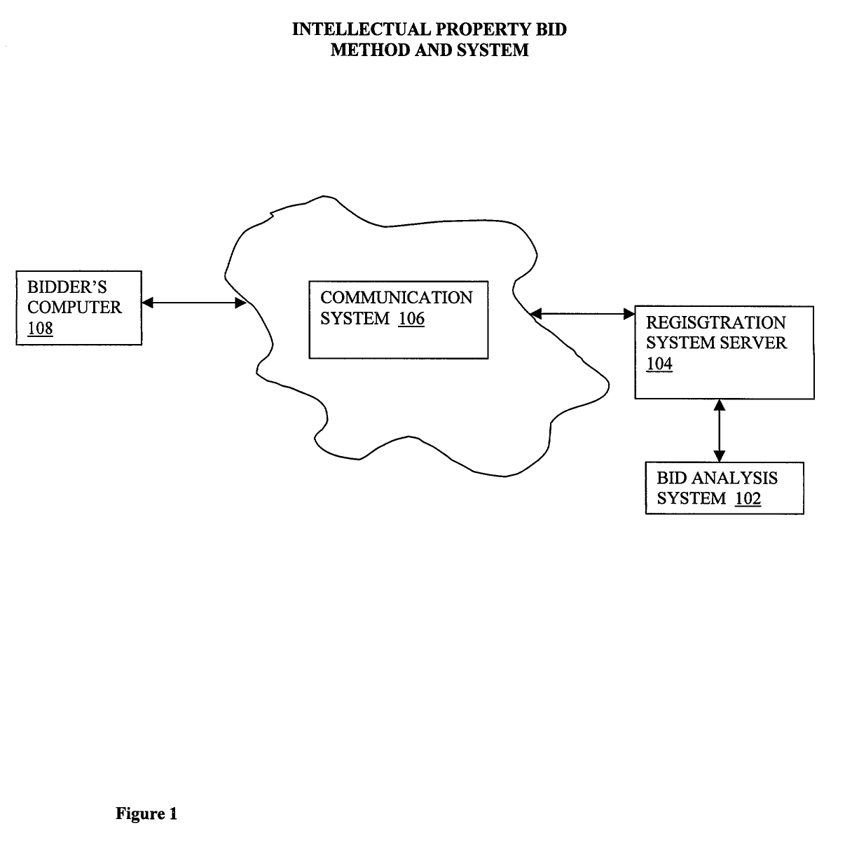

Referring now to the drawings, wherein like reference numerals designate identical or corresponding parts throughout the several views, and more particularly to FIG. 1 thereof, an exemplary embodiment of the system illustrative of the present invention is shown. The system includes a bid analysis system 102, a registration system server 104, a communication system 106, and a bidder's computer 108. The bidder's computer 108 is communicatively interconnected via a communication system 106. The communication system 106 is any system allowing the bidder to communicate with the registration server system 104 and the bid analysis system 102. The communication means includes facsimile, public or private telephone, Intranet, or external network such as the Internet, the World Wide Web, or another network, commercial mails such as UPS or Federal Express and regular mail as provided by the United States post office.

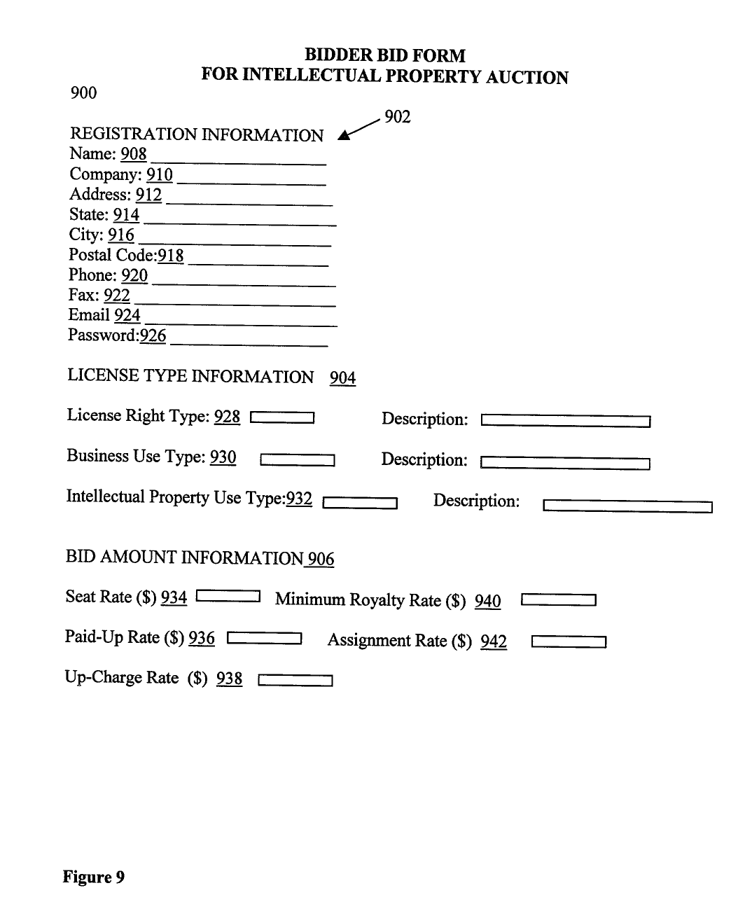

The registration server system 104 can be a Web server programmed to receive, retrieve, store, and transmit many types of information including bid information 900, which is described below in FIG. 9. The registration system server 104 accepts a bidder's registration information 900 for the purpose of identifying a bidder with a bidder's bids in an intellectual property auction. The registration system server 104 creates a unique registration number 302 to index the bids and the bidder information in the registration server system 104. Like the bidder's computer 108, the registration server system 104 is communicatively interconnected via the communication system 106 to the bidder's computer 108.

The bid analysis system 102 is connected to the registration server system 104 to accept bid information except the bidder's registration information. The registration server system 104 in communication with the communication system 106 accepts or rejects bidder bid information 900, after verifying the existence of a bidder 108 in the registration database 210.

Each bidder is provided a unique registration number 302 after the registration system server 104 qualifies the entity or individual registering called the registrant. Qualifying the registrant means verifying the supplied information has recognizable informational content in a name 908 field, a company 910 field, an address 912 field, a city 916 field, a state 914 field, and a postal code 918 field. Next, the registration server system 104 electronically sends the bid amount information 900 over to the bid analysis system 102 for indexing into a bid analysis database 212. Any bids not verifying or not validating, the bid analysis system 102 rejects for manual processing.

The bidder's computer 108 may be any computer that a bidder can access, such as home or office computer. The bidder's computer 108 may be programmed to work with any suitable web browser software to retrieve the Web pages via the communications system 106 operating on the Internet from a remote server such as the registration server system 104. The bidder may use the Web browser on its computer 108 to transmit bid information 900 to the registration server system 104.

It is emphasized that the system of FIG. 1 is for exemplary purposes only, as many variations of the hardware used to implement the present invention will be readily apparent to one having ordinary skill in the art. For example, the communications system 106 the bidder can substitute regular mail or commercial mail to send its bid information 900 for registration server system 104 input. And tracking of the bids could be done manually on a paper ledger.

The present invention stores in one or more memories such as a hard disk, optical disk, and/or RAM, for example, a bidder's information relating to each bidder's bid. The stored information may include registration information, bid amount information, license type, business use and/or intellectual property use information, for example. The databases organize the information in data structures such as records, tables, arrays, fields, and/or lists contained in a memory unit such as a hard disk, floppy disk or RAM, for example.

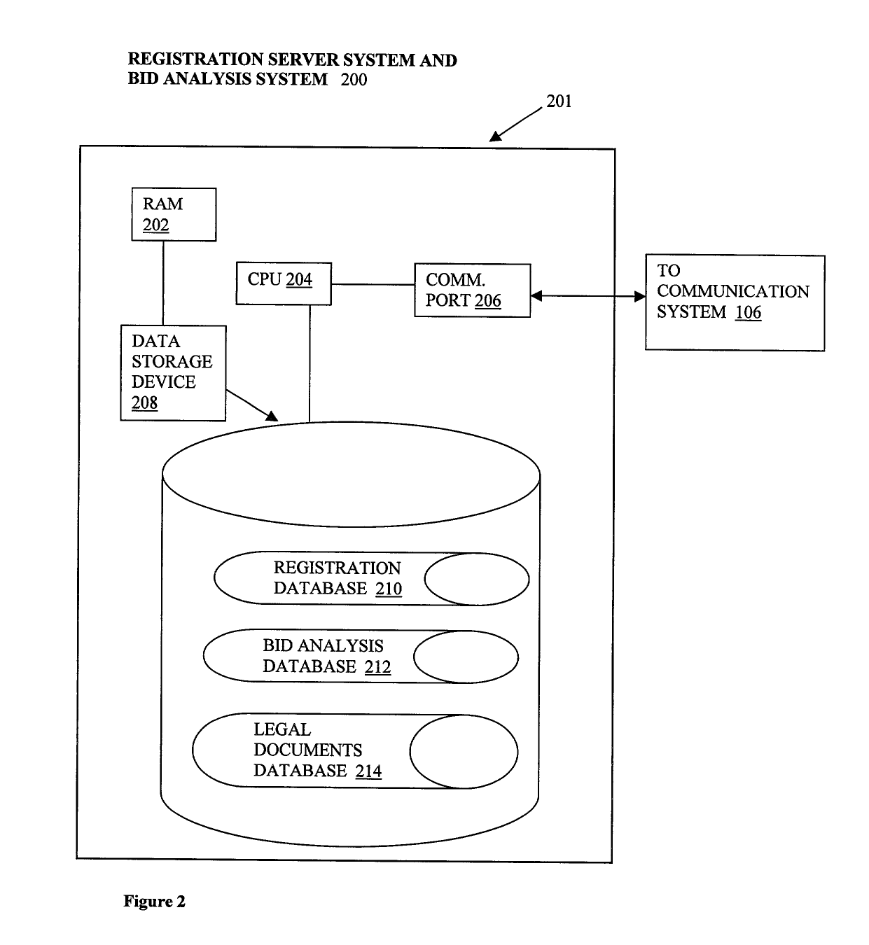

FIG. 2 illustrates a block diagram of an exemplary server system 201 of a registration server system and a bid analysis system 200. The registration server system 200 performs all the operations of a standard server system and, performs addition operations in accordance with the present invention, as discussed in detail hereinafter. The server system 201 contains a CPU 204 and RAM 202 for processing registration information, bid amount information, and license type information. The CPU 204 is coupled to the communications system 106 via a communications port 206 to send or to receive registration information and/or bid information. As shown in FIG. 2 the CPU 204 is coupled to a data storage device 208.

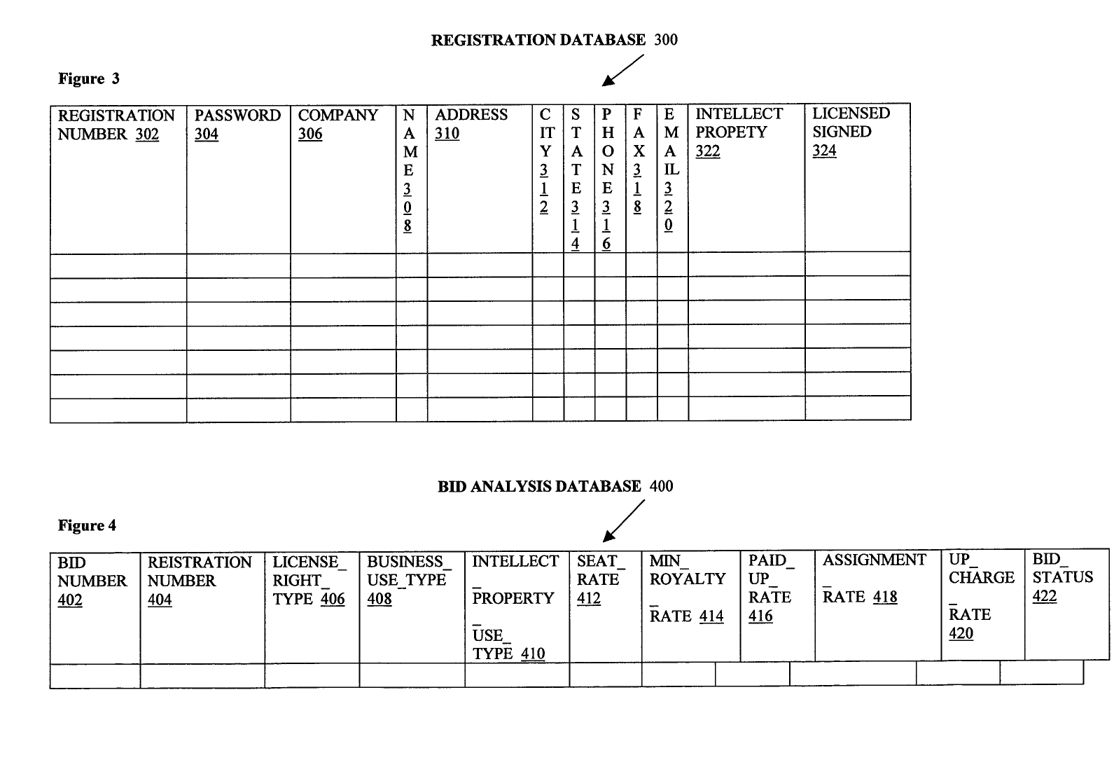

Data storage device 208 contains a variety of databases including a registration database 210, a bid analysis database 212, and a legal document database 214. The registration database 210 of data storage device 208 contains registration information of the person registering the bid, called the registrant. The bid analysis database 212 contains bid amount information and license type information on the intellectual property of interest. The legal document database 214 contains contracts, licenses, and other legal forms necessary to complete the transaction between a bidder and an intellectual property owner. The registration and bid analysis databases will be discussed in more detail hereinafter in conjunction with FIGS. 3-4.

FIG. 3 illustrates an exemplary registration database 300, which records each bidder's bid offer on an intellectual property at auction. As previously stated, when a bidder attempts to bid a record of the bidder's location and contact information is preferably established in the registration database 210. In addition, new records are created for each new intellectual property offered for auction to aid in preventing disclosure of a registrant bidding on many different intellectual properties. As a stated objective, confidentiality is an important issue for bidders, especially when a bidder is a competitor to the intellectual property owner. For example, a bidder can make an offer on the intellectual property as a whole, or just on a claim, if offered for bid, with the bidder having two unique registration numbers, or at least two separate bid numbers discussed herein in FIG. 4.

The exemplary data structure of the registration database 300 as shown in FIG. 3 includes a registration number 302 field. The registration number is unique to index the registration information 900 and to prevent the intellectual property owner from identifying the registrant bidding. The data structure may include a password 304 field the registrant provides to further protect its registration information from disclosure. For each registration number 302, the registration database 300 includes a field for a company name 306, field for a name 308, field for an address 310, field for a city 312, field for a state 314, field for a phone 316, field for a fax 318, field for an electronic mail (email) 320, field for an intellectual property 322 and field for a license signed 324.

The company name field 306 helps distinguish between an individual bidding, or an individual bidding on behalf of a company. The name field 308 identifies the individual to be contacted at the close of bidding, if determined the winning bidder. The address 310 field, city 312 field, state 314 field, phone 316 field, fax 318 field, and email 320 field provide for additional contact information. The license signed 324 field provides for the firm bid offer by the bidder for the intellectual property 322. Finally, the registration database 300 preferably records a unique registration number 302 for each set of bids offered on a patent or patent claim 322. The registrations can be recorded in real-time as the bid offers arrive, or by means of batch processing on a periodic basis.

FIG. 4 illustrates an exemplary bid analysis database 400 which preferably stores specific bid information for each bid made by a unique registration number 302 based on specific license type information in fields 406-410 on the intellectual property 322 of interest. The intellectual property includes at least a patent, a patent claim, a trademark, a copyright, a Mask Work, and a software. The bid analysis database 400 maintains a plurality of bid records, each associated with a specific intellectual property based upon unique license type information.

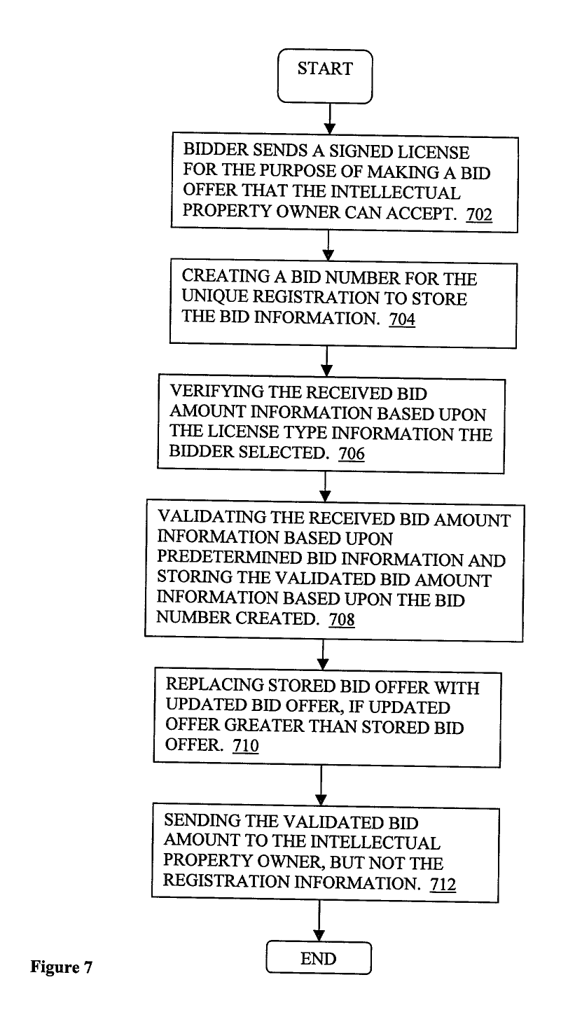

Prior to storing each bid record, the bid analysis system 201 verifies that a bidder has not replaced a received bid with a lower subsequent bid for an already stored received bid offer. For each bid number 402 received, the bid analysis database 400 includes a field for a secure registration number 404, and license type information that includes at least a field for a license right type 406, field for a business use type 408, and field for an intellectual property use type 410. The bid number 402 field is provided to index the received bids in the bid analysis database 400. The license type information fields 406 to 410 are further discussed in FIG. 7 on steps 706 and 708 below.

As shown in FIG. 4, bid amount information includes at least a field for a seat rate 412, field for a minimum royalty rate 414, field for a paid-up rate 416, field for an assignment rate 418, and field for an up-charge rate 420. All rates are converted to a common currency, such as US dollars. The seat rate 412 field provides for a minimum dollar value for each individual use of the intellectual property. The minimum royalty rate 414 field provides for a yearly minimum dollar rate regardless if the licensee uses the intellectual property owner. The minimum royalty rate 414 field helps prevent a competitor from licensing the intellectual property 322 and not using the property for which the owner would get zero seat based revenue. The paid-up rate 416 field provides for the intellectual property owner a minimum fee based upon an estimated number of seats. The up-charge rate 420 field provides for a dollar increase to cover additional costs based on a seat or a fixed amount. The assignment rate 418 field provides for a dollar payment based upon assigning certain intellectual property rights to the licensee.

For each rate field, the bid analysis system 200 has a minimum bid amount based upon the specific license type information the bidder submitted. Any received bid amount information falling below the predetermined minimum bid amount, the bid analysis system 200 rejects the bid offer. For example, a non-exclusive license in the programmable logic controller business for a specific patent in that field of use, a rate field 412 to 420 falling below the minimum bid amount for the rate field 412 to 420, the bid analysis system 200 rejects the bid offer. The bid analysis system communicates with the bidder that its bid offer failed. The bid analysis system deletes the registration record. The intellectual property owner has no knowledge of the failed bid offer.

As shown FIG. 4 each bid record stored has a bid status 422 field for the purpose of informing the bid analysis system 200 of what to do with the bid record. For example, the auction completed on the intellectual property, so the bid analysis system 200 will delete the non-winning bid. In another example, the bid analysis system 200 determined the bid record as the winning bid. The bid analysis system 200 may set the bid status 422 field to in-process, if the bid analysis system is in-process of accepting the bid offer, or set the bid status 422 field to complete, if the winning bidder has been contacted. Once the winning bid responds, the bid analysis system 200 could set the bid status 422 field to close.

The data structures embodied by the present invention include the data structures shown in FIGS. 3 and 4 and described above. Alternatively, any other desired manner of implementing the data structures embodied by the present invention may be equivalently implemented so that desired functionality and corresponding practical application are achieved.

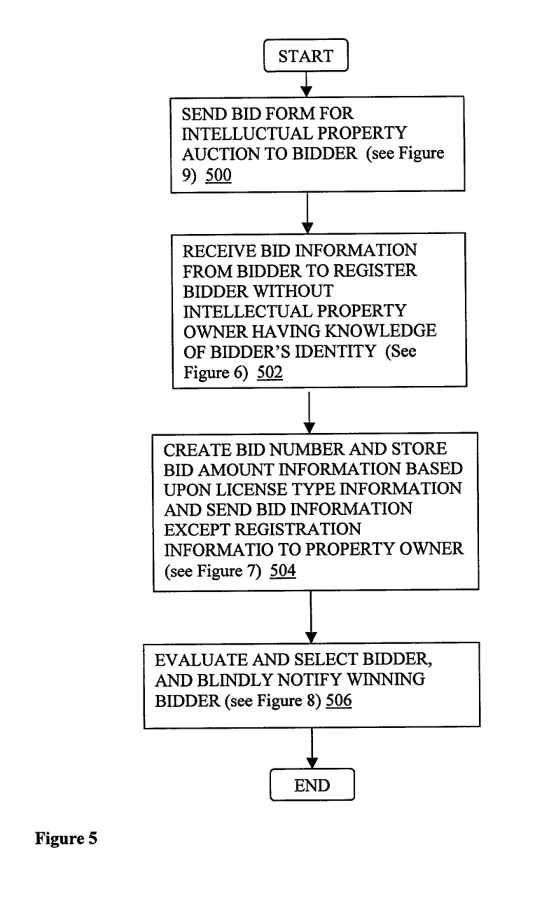

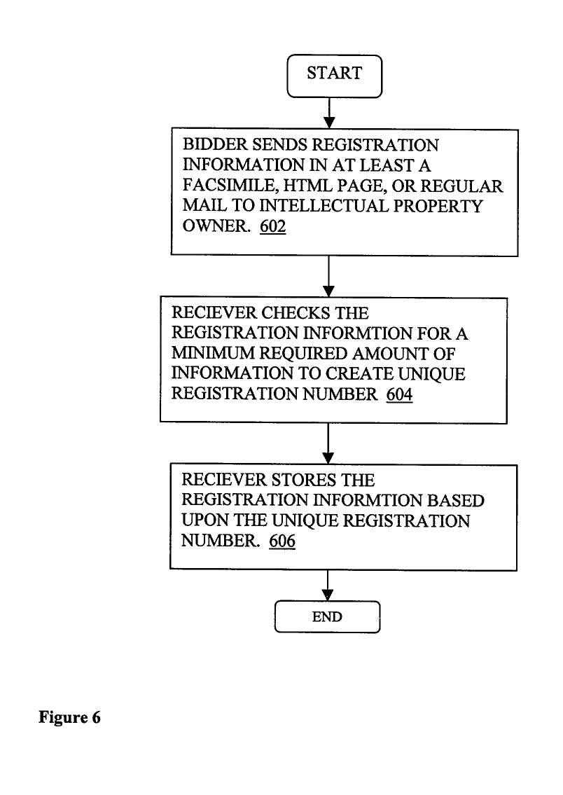

FIG. 5 is a flowchart that shows the general process for implementing the invention. Each of the steps of FIG. 5 includes two or more sub-steps described below in FIGS. 6, 7, and 8.

Referring back to FIG. 5, the registration database 300 is populated with bidders having placed a bid offer after returning a sent bid form 500 containing the intellectual property for auction. Further details of this step are described below in FIG. 9. Received bid forms 900 are organized into at least two separate records, each corresponding to the unique registration number 302 and to the bid number 402. The bid analysis system 102 maintains the link between the bid number 402 and the registration number 302.

In step 502, each bidder returns the bid form 900 to the registration system server 104 which checks the bid form 900 for registration information fields 912 to 928, contained therein, and stores the registration information in the registration database 210. Further details of step 502 and the registration process are set forth in the description of FIG. 6.

In step 504, the registered bidders have bid amount information 906 and license type information 904 verified, validated, and stored in the bid analysis database 212 based upon a bid number 402, the bid analysis system 102 creates. Further details of step 504 are set forth in the description of FIG. 7.

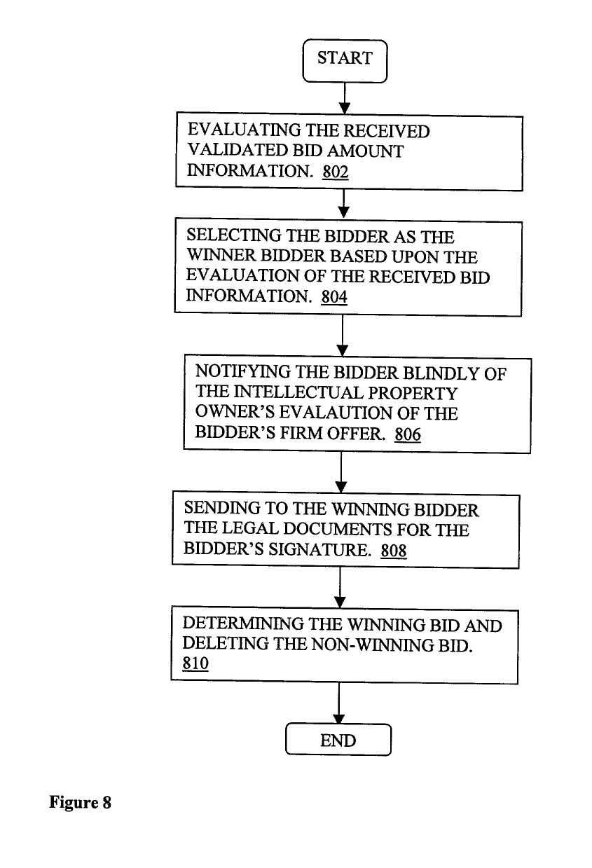

In step 506, the bid analysis system 200 based upon inputs received by the intellectual property owner evaluates and selects the winning bidder. Further details of step 506 are set forth in the description of FIG. 8.

FIG. 6 is a flowchart of the process of step 502 of FIG. 5 and shows how the sent bid form 900 is accepted after received by the registration server system and bid analysis system 201, and checked for minimum required amount of information to register the bidder. Step 602 accepts the bid form 900 containing the registration information 902 in at least a facsimile, html page, or regular mail. Regular mail is mail sent via the U.S. Post Office. Step 604 checks the contents of fields 908 to 926 from bid form 900, as the information enters the registration database 210. For example, a state 914 field having a valid two-digit state code such as ‘MA’, the registration database 210 would accept. Likewise, a check of the postal code 918 field could result in a registration database 210 rejection.

Prior to the completion of Step 604, but after the registration information 902 fields 908-926 are checked for its contents, step 604 creates the registration number 302. Step 606 stores the received and checked registration information 902 in the registration database 210 based upon the unique registration number 302 created in step 604. Steps 602, 604, and 606 may be repeated as necessary to create records for additional bidders Updates to an already created record may occur, but the process may result in manual intervention because a valid bid has already been accepted against the registration record.

FIG. 7 is a flowchart showing how the bidder makes a bid offer and the registration server system and bid analysis system 201 stores the bid offer. In step 702, the bidder, as part of the received bid form 900, has returned a signed license. The signed license is a firm offer from the bidder that the intellectual property owner can accept, if the bid analysis system 102 determines the bidder is the winning bid. The license generated is based upon the contents of the license type information 904 fields 928 to 932 that the bidder entered into its bid form 900.

In step 704, the unique bid number 402 is created for the bid form 900. The registration server system and bid analysis system 201 associates the bid number 402 with the registration number 302 without the intellectual property owner having knowledge of the entity or individual making the bid offer. This helps protect the bidder from subjective decisions the intellectual property and helps provide the bidder, a potential competitor, with confidentiality. In addition, step 704 indexes license type information 904 and bid amount information 906 in the bid analysis database 400 based upon the bid number 402.

In step 706, each piece of bid amount information 906 contained in fields 934 to 942 is verified based upon the license type information 904 contained in fields 928 to 932 the bidder submitted on its bid form 900. For example, a bidder selecting a license right type 928 of “A”, a business use type 930 of “B”, and an intellectual property use type 932 of “C” defines the minimum bid amount information 906. A bidder has a mechanism to submit bid amount information 906 for a seat rate field 934, for a paid-up rate field 936, for a up-charge rate field 938, for a minimum royalty rate field 940, and for an assignment rate field 942 on the bid form 900, representing the bid offer, depending upon the license type information 904 selected. Step 706 verifies that the bidder has entered a dollar value into the bid amount information fields 934 to 942 depending upon the license type information 904 selected.

In step 708, the verified bid amount information 906 equals at least a minimum predetermined bid amount information. Prior to the auction, the intellectual property owner submits to the registration server system and bid analysis system 201 a minimum bid amount based upon various approved license type information 904 field 928 to 932 combinations. In Step 708 that step validates that the received bid amount information 906 meets the predetermined minimum bid amount. For example, if the license type information 904 in step 702 above resulted in the seat rate 934, the minimum royalty rate 940, and the up-charge rate 938 anyone of these rates falling below the predetermined minimum rate would reject the bidder's bid form 900, as the bid offer. However, the bid amount information 906 meeting or exceeding the predetermined bid amount information would be stored as a valid bid offer as a record in the bid analysis database 400.

In step 710, a bid form 900 has been accepted, but the bidder knowing its bid number 402 re-submits a new bid under the same license type information 904 and the same intellectual property 322. The registration server system and bid analysis system 201 would reject any bid form 900 having bid amount information 906 lower than the bidder's prior firm offer. For example, the bid amount information 906 of step 708 above that meets or exceeds the predetermined minimum, will result in step 708 storing the validated bid amount information 906 indexed based upon the bid number 402. The next incoming bid form 900 having the same registration number and meeting steps 702, 704, and 706 step 710 will set the bid status to delete on the stored bid offer. Step 710 will store the received bid offer as the current bid offer only if the received bid amount exceeds the stored bid amount information field by field.

In step 712, validated bid amount information 906 including the bid number 402 will be sent to the intellectual property owner, but not the registration number 322. This includes any updated bid meeting step 710.

FIG. 8 is a flowchart of evaluating, selecting, and notifying a winning bidder and sending legal documents to the winning bid, and deleting any non-winning bids. The intellectual property owner having received the bid offers from step 712 has the necessary information to determine a winning bid. In step 802, the intellectual property owner evaluates the received validated bid amount information 906. A seat is single user having the right to use the intellectual property auctioned. For example, the owner might evaluate by multiplying the seat rate 934 by an estimated number of seats that the business use type 930 may sell. Adding in the minimum royalty rate 940 and the up-charge rate 938 the owner may determine the winning bidder by the highest total dollar of the bid offer. Alternatively, the owner may determine another bid offer having a lower seat rate 934, but a higher minimum royalty rate 940 may yield a higher overall fee. Yet, another intellectual property owner might select based upon the intellectual property use type 932 being patent claims, instead of the patent itself. The owner might sell the patent claims for a strategic reasons, not necessarily financial reasons.

As one skilled in the art can see the owner's evaluation method can take many forms based upon the license type information 904 and the bidder's bid amount information 906 accepted. In step 804, the owner selects the winning bidder for each license right type 928, business use type 930 and intellectual property use type 932 based upon the owner's evaluation in step 802. The license right type 928 field provides for many different legal rights for access to the intellectual property. For example, a license right type 928 may be a non-exclusive license providing the intellectual property owner with the opportunity to license in more than one business use type 930. With the nonexclusive license, the owner may license the intellectual property in two different industries. For example, intellectual property useful in the gas and oil industry may be licensed to two competitors one in each field. In addition, the bidder may select an intellectual property use type 932 of a right to exclude others. The bidder may not use the intellectual property, but may want to exclude others from using a similar technology resulting in a similar product.

In step 806, the owner submits to the registration server system and bid analysis system 201 its winning bidders based upon the bid number 402. Because the owner cannot determine the registration information 902 based upon the bid number 402 step 806 blindly notifies the winning bidder. As part of the notification, the winning bidder in step 808 receives the final legal paperwork to be signed and returned. Upon receipt of the final paperwork, the winning bidder is determined for the license type information 904. The non-winning bidders for the license type information 904 are deleted in step 808. Any bidder requesting a modification to the standard license for the selected license type information 904 would reveal their identity to the intellectual property owner prior to the close of the auction.

This invention may be conveniently implemented using a conventional general purpose computer or micro-processor programmed according to the teachings of the present invention, as will be apparent to those skilled in the computer art. Appropriate software can be readily prepared by programmers of ordinary skill based on the teachings of the present disclosure, as will be apparent skilled in the software art.

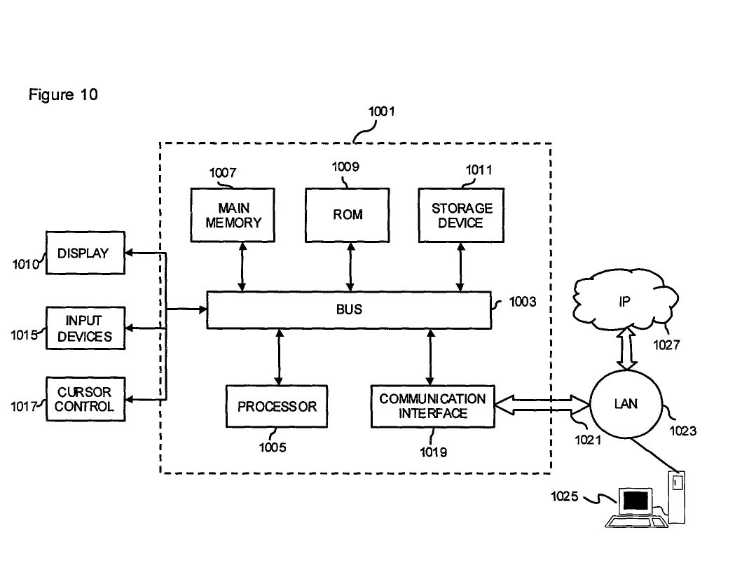

FIG. 10 illustrates a computer system 1001 upon which an embodiment according to the present invention may be implemented. Computer system 1001 includes a bus 1003 or other communication mechanism for communicating information, and a processor 1005 coupled with bus 1003 for processing the information. Computer system 1001 also includes a main memory 1007, such as a random access memory (RAM) or other dynamic storage device, coupled to bus 1003 for storing information and instructions to be executed by processor 1005. In addition, main memory 1007 may be used for storing temporary variables or other intermediate information during execution of instructions to be executed by processor 1005. Computer system 1001 further includes a read only memory (ROM) 1009 or other static storage device coupled to bus 1003 for storing static information and instructions for processor 1005. A storage device 1011, such as a magnetic disk or optical disk, is provided and coupled to bus 1003 for storing information and instructions.

Computer system 1001 may be coupled via bus 1003 to a display 1010, such as a cathode ray tube (CRT), for displaying information to a computer user. An input device 1015, including alphanumeric and other keys, is coupled to bus 1003 for communicating information and command selections to processor 1005. Another type of user input device is cursor control 1017, such as a mouse, a trackball, or cursor direction keys for communicating direction information and command selections to processor 1005 and for controlling cursor movement on display 1010.

According to one embodiment, mapping a set of object life cycle states to one or more sets of business rules is provided by computer system 1001 in response to processor 1005 executing one or more sequences of one or more instructions contained in main memory 1007. Such instructions may be read into main memory 1007 from another computer-readable medium, such as storage device 1011. Execution of the sequences of instructions contained in main memory 1007 causes processor 1005 to perform the process steps described herein. One or more processors in a multi-processing arrangement may also be employed to execute the sequences of instructions contained in main memory 1007. In alternative embodiments, hard-wired circuitry may be used in place of or in combination with software instructions. Thus, embodiments are not limited to any specific combination of hardware circuitry and software.

Further, the mapping of notifications to business rule triggers may reside on a computer-readable medium. The term a “computer-readable medium” as used herein refers to any medium or media that participate in providing instructions to processor 1005 for execution. Such a medium may take many forms, including but not limited to, non-volatile media, volatile media, and transmission media. Non-volatile media includes, for example, optical or magnetic disks, such as storage device 1011. Volatile media includes dynamic memory, such as main memory 1007. Transmission media includes coaxial cables, copper wire and fiber optics, including the wires that comprise bus 1003. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1005 for execution. For example, the instructions may initially be carried on a magnetic disk of a remote computer. The remote computer can load the instructions relating to the notification services to control call processing remotely into its dynamic memory and send the instructions over a telephone line using a modem. A modem local to computer system 1001 can receive the data on the telephone line and use an infrared transmitter to convert the data to an infrared signal. An infrared detector coupled to bus 1003 can receive the data carried in the infrared signal and place the data on bus 1003. Bus 1003 carries the data to main memory 1007, from which processor 1005 retrieves and executes the instructions The instructions received by main memory 1007 may optionally be stored on storage device 1011 either before or after execution by processor 1005.

Computer system 1001 also includes a communication interface 1019 coupled to bus 1003. Communication interface 1019 provides a two-way data communication coupling to a network link 1021 that is connected to a local network 1023. For example, communication interface 1019 may be a network interface card to attach to any packet switched local area network (LAN). As another example, communication interface 1019 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 1019 sends and receives electrical, electromagnetic or optical signals that carry digital data streams representing various types of information.

Network link 1021 typically provides data communication through one or more networks to other data devices. For example, network link 1021 may provide a connection through local network 1023 to a host computer 1025 or to data equipment operated by a service provider, which provides data communication services through an IP (Internet Protocol) network 1027 (e.g., the Internet). LAN 1023 and IP network 1027 both use electrical, electromagnetic or optical signals that carry digital data streams. The signals through the various networks and the signals on network link 1021 and through communication interface 1019, which carry the digital data to and from computer system 1001, are exemplary forms of carrier waves transporting the information. Computer system 1001 can transmit notifications and receive data, including program code, through the network(s), network link 1021 and communication interface 1019.

The many features and advantages of the present invention are apparent from the detailed specification, and thus, it is intended from the appended claims to cover all features and advantages of the invention which fall within the scope of the invention.

Furthermore, since numerous modifications and variations will readily occur to those skilled in the art, it is not desired to limit the present invention to the exact construction and operation illustrated and described herein, and accordingly, all suitable modifications and equivalents which may be restored to are intended to fall within the scope of the claims.

We claim:

1. A method comprising the steps of:
sending a bidder a bid form for an intellectual property auction for auctioning intellectual property of an intellectual property owner, the bid form prompting the bidder to enter bid information including registration information identifying the bidder, license type information, and bid amount information;
receiving from the bidder bid information comprising registration information, license type information, and bid amount information; and
sending to the owner of the intellectual property the license type information and the bid amount information, while withholding from the intellectual property owner the registration information until at least the conclusion of the auction.

2. The method of claim 1, wherein the step of sending comprises sending the bid information in at least a facsimile, html page, and regular mail.

3. The method of claim 1, wherein the step of receiving includes checking for duplicate bidders and storing the bid information; and
wherein the method further comprises the step of validating and registering the bidder.

4. The method of claim 3, wherein the method further comprises the step of receiving a signed license from the bidder to validate the bidder.

5. The method of claim 3, wherein the method further comprises the step of checking the registration information for a minimum required amount of registration information, the minimum required amount of registration information including at least one of a password, name, company, street, city, state, postal code, phone number, fax number, and a working electronic mail address.

6. The method of claim 3, wherein the method further comprises the steps of:
creating a unique registration number from the minimum required registration information;
storing the minimum amount of registration information in a registration file system; and
indexing the registration information based upon the unique registration number.

7. The method of claim 3, wherein the method further comprises the steps of:
creating a bid number for the bid of the unique registration number;
storing the bid information;
verifying the bid amount information based upon the license type information; and
validating the bid amount information.

8. The method of claim 7, wherein the method further comprises the step of checking the license type information for a minimum required amount of license type information, the minimum required amount of license type information comprising a license right type, business use type, and an intellectual property use type.

9. The method of claim 8, wherein the method further comprises the step of verifying the bid amount information for the minimum required amount of bid amount information, the minimum required amount of bid amount information comprising at least one of a seat rate, a minimum royalty rate, a paid-up rate, an assignment rate, and an up-charge rate, further selected by the license type information.

10. The method of claim 8, wherein the method further comprises the steps of checking the intellectual property right type information for a minimum required amount of intellectual property use type information comprising at least one of a patent license, a patent claim license, a copyright license, software license and a trademark license, further selected by a right to use, a right to make, and a right to exclude.

11. The method of claim 10, wherein the method further comprises the step of validating the received bid amount information based upon a predetermined bid amount information comprising at least one of a seat rate, a minimum royalty rate, a paid-up rate, an assignment rate, and an up-charge rate, by rejecting the received bid amount information that does not compile with the predetermined bid amount information.

12. The method of claim 11, wherein the method further comprises the steps of:
checking the received bid amount information against a stored bid amount information;
rejecting the received bid amount, if any of the received bid amount information is a lower amount than any of the stored bid amount information;
storing the non-rejected validated bid amount information in a bid analysis file system; and indexing the bid amount information based upon the bid number

13. The method of claim 1, further comprising the steps of:
evaluating the sent bid amount information and license type information;
selecting the bidder as the winning bidder; and
blindly notifying the winning bidder, unless a standard license change, based upon the registration number indexed with the bid number.

14. The method of claim 13, wherein the method further comprises the steps of:
receiving from the winning bidder a confirming message including information identifying the winning bidder; and
sending to the winning bidder the legal documents associated with the license type information.

15. The method of claim 1, further comprising determining whether the bid is a winning bid; and deleting the bid if it is not the winning bid.

16. A computer readable medium containing program instructions for execution on a computer system, which when executed the computer system, cause the computer system to perform method steps for auctioning an intellectual property, said method comprising the steps of:
sending a bidder a bid form for an intellectual property auction for auctioning intellectual property of an intellectual property owner, the bid form prompting the bidder to enter bid information including registration information identifying the bidder, license type information, and bid amount information;
receiving from the bidder bid information comprising registration information, license type information, and bid amount information; and
sending to the owner of the intellectual property the license type information and the bid amount information, while withholding from the intellectual property owner the registration information until at least the conclusion of the auction.

17. The computer readable medium of claim 16, wherein the step of sending comprises sending the bid information in at least a facsimile, html page, and regular mail.

18. The computer readable medium of claim 16, wherein the step of receiving includes checking for duplicate bidders and storing the bid information; and
wherein the computer readable medium further comprises instructions for the computer system to perform the steps of validating and registering the bidder.

19. The computer readable medium of claim 18, wherein the computer readable medium further comprises the step of receiving a signed license from the bidder to validate the bidder.

20. The computer readable medium of claim 18, wherein the computer readable medium further comprises instructions for the computer system to perform the step of checking the registration information for a minimum required amount of registration information, the minimum required amount of registration information including at least one of a password, name, company, street, city, state, postal code, phone number, fax number, and a working electronic mail address.

21. The computer readable medium of claim 18, wherein the computer readable medium further comprises the steps of:
creating a unique registration number from the minimum required registration information;
storing the minimum amount of registration information in a registration file system; and
indexing the registration information based upon the unique registration number.

22. The computer readable medium of claim 18, wherein the computer readable medium further comprises instructions for the computer system to perform the steps of:
creating a bid number for the bid of the unique registration number;
storing the bid information;
verifying the bid amount information based upon the license type information; and
validating the bid amount information.

23. The computer readable medium of claim 22, wherein the computer readable medium further comprises instructions for the computer system to perform the step of checking the license type information for a minimum required amount of license type information, the minimum required amount of license type information comprising a license right type, business use type, and an intellectual property use type.

24. The computer readable medium of claim 23, wherein the computer readable medium further comprises instructions for the computer system to perform the step of verifying the bid amount information for the minimum required amount of bid amount information, the minimum required amount of bid amount information comprising at least one of a seat rate, a minimum royalty rate, a paid-up rate, an assignment rate, and an up-charge rate, further selected by the license type information.

25. The computer readable medium of claim 23, wherein the computer readable medium further comprises instructions for the computer system to perform the steps of checking the intellectual property right type information for a minimum required amount of intellectual property use type information comprising at least one of a patent license, a patent claim license, a copyright license, a software license, and a trademark license, further selected by a right to use, a right to make, and a right to exclude.

26. The computer readable medium of claim 25, wherein the computer readable medium further comprises instructions for the computer system to perform the step of validating the received bid amount information based upon a predetermined bid amount information comprising at least one of a seat rate, a minimum royalty rate, a paid-up rate, an assignment rate, and an up-charge rate, by rejecting the received bid amount information that does not compile with the predetermined bid amount information.

27. The computer readable medium of claim 26, wherein the computer readable medium further comprises instructions for the computer system to perform the steps of:
checking the received bid amount information against a stored bid amount information;
rejecting the received bid amount, if any of the received bid amount information is a lower amount than any of the stored bid amount information;
storing the non-rejected validated bid amount information in a bid analysis file system;
and indexing the bid amount information based upon the bid number

28. The computer readable medium of claim 16, further comprising the steps of:
evaluating the sent bid amount information and license type information;
selecting the bidder as the winning bidder; and
blindly notifying the winning bidder, unless a standard contract change, based upon the registration number indexed with the bid number.

29. The computer readable medium of claim 28, wherein the computer readable medium further comprises instructions for the computer system to perform the steps of:
receiving from the winning bidder a confirming message including information identifying the winning bidder; and
sending to the winning bidder the legal documents associated with the license type information.

30. The computer readable medium of claim 16, further comprising determining whether the bid is a winning bid; and deleting the bid if it is not the winning bid.

31. A system for auctioning an intellectual property, comprising:
means for sending a bidder a bid form for an intellectual property auction for auctioning intellectual property of an intellectual property owner, the bid form prompting the bidder to enter bid information including registration information identifying the bidder, license type information, and bid amount information;
means for receiving from the bidder bid information comprising registration information, license type information, and bid amount information; and
means for sending to the owner of the intellectual property the license type information and the bid amount information, while withholding from the intellectual property owner the registration information until at least the conclusion of the auction.

32. The system of claim 31, wherein the means for sending comprises sending the bid information in at least a facsimile, html page, and regular mail.

33. The system of claim 31, wherein the means for receiving includes means for checking for duplicate bidders and storing the bid information; and
wherein the system further comprises the means for validating and registering the bidder.

34. The system of claim 33, wherein the system further comprises the means for receiving a signed license from the bidder to validate the bidder.

35. The system of claim 33, wherein the system further comprises the means for checking the registration information for a minimum required amount of registration information, the minimum required amount of registration information including at least one of a password, name, company, street, city, state, postal code, phone number, fax number, and a working electronic mail address.

36. The system of claim 33, wherein the system further comprises the means for:
creating a unique registration number from the minimum required registration information;
storing the minimum amount of registration information in a registration file system; and
indexing the registration information based upon the unique registration number.

37. The system of claim 33, wherein the system further comprises the means for:
creating a bid number for the bid of the unique registration number;
storing the bid information;
verifying the bid amount information based upon the license type information; and
validating the bid amount information.

38. The system of claim 37, wherein the system further comprises the means for checking the license type information for a minimum required amount of license type information, the minimum required amount of license type information comprising a license right type, business use, and an intellectual property use type.

39. The system of claim 38, wherein the system further comprises the means for verifying the bid amount information for the minimum required amount of bid amount information, the minimum required amount of bid amount information comprising at least one of a seat rate, a minimum royalty rate, a paid-up rate, an assignment rate, and an up-charge rate, further selected by the license type information.

40. The system of claim 38, wherein the system further comprises the means for checking the intellectual property right type information for a minimum required amount of intellectual property use type information comprising at least one of a patent license, a patent claim license, a copyright license, a software license, and a trademark license, further selected by a right to use, a right to make, and a right to exclude.

41. The system of claim 40, wherein the system further comprises the means for validating the received bid amount information based upon a predetermined bid amount information comprising at least one of a seat rate, a minimum royalty rate, a paid-up rate, an assignment rate, and an up-charge rate, by rejecting the received bid amount information that does not compile with the predetermined bid amount information.

42. The system of claim 41, wherein the system further comprises the means for:
checking the received bid amount information against a stored bid amount information;
rejecting the received bid amount, if any of the received bid amount information is a lower amount than any of the stored bid amount information;
storing the non-rejected validated bid amount information in a bid analysis file system; and
indexing the bid amount information based upon the bid number.

43. The system of claim 31, further comprising the means for:
evaluating the sent bid amount information and license type information;
selecting the bidder as the winning bidder; and
blindly notifying the winning bidder, unless a standard contract change, based upon the registration number indexed with the bid number.

44. The system of claim 43, wherein the system further comprises the means for:
receiving from the winning bidder a confirming message including information identifying the winning bidder; and
sending to the winning bidder the legal documents associated with the license type information.

45. The system of claim 30, further comprising determining whether the bid is a winning bid; and deleting the bid if it is not the winning bid.
